(19) United States
(12) Patent Application Publication
(10) Pub. No.: US 2002/0105310 A1
(43) Pub. Date: Aug. 8, 2002

(54) Voltage adjustment system and method

(76) Inventor: Stephen R. Loyer, Gilbert, AZ (US)

Correspondence Address: Baker Botts L.L.P., One Shell Plaza, 910 Louisiana Street, Houston, TX, 77002-4995, US

(21) Appl. No.: 09/778,293

(22) Filed: Feb. 6, 2001

(51) Int. Cl. G05F 1/40

(52) U.S. Cl. 323/283

(57) ABSTRACT

A resistor is modified in accordance with a first adjustment. A voltage is measured at a particular temperature. The measured voltage is compared to the bounds of an initial range. If the voltage is outside the initial range, the first adjustment is changed and the measurement at the particular temperature is repeated. The resistor is modified in accordance with both the first adjustment and a second adjustment. The voltage is measured at a new temperature. If the voltage measured at the new temperature does not fall within a specific range, the second adjustment is changed and the measurement at the new temperature is repeated.

### BACKGROUND OF THE INVENTION

The invention relates to electronic circuitry and, more particularly, to a system and method that result in an adjusted voltage.

### DESCRIPTION OF THE RELATED TECHNOLOGY

Electronic devices utilize voltages and currents in their operation. Specific points in the circuit can utilize a defined voltage, current, or other characteristic to bias a circuit element, provide a reference for comparison, and for many other purposes. The accuracy of electronic circuit operations is often directly dependent upon the accuracy of defined voltages and other characteristics used by the circuit.

Electronic device manufacturers also must consider the changes in device characteristics that occur with temperature. For example, a reference voltage can properly bias a transistor at a particular temperature, but fail at a higher temperature. In one instance, the circuit that produces the reference voltage is affected by the change in temperature such that its output changes appreciably. In another instance, the transistor's characteristics change with temperature. In that case, the reference voltage needs to change as well to do its job. A manufacturer of electronic devices may require both a temperature independent reference voltage and a reference voltage that has a specific temperature dependence. In addition, in the manufacture of CMOS devices, rather large offset voltages must be accommodated. The temperature dependence of a particular reference voltage is often described by its temperature coefficient. The output voltage of a bandgap voltage reference is described by Vₒᵤₜ=K₁(K₂φ_{T}ln(A₂/A₁)+V_{BE}) where φ_{T} increases with temperature and V_{BE} decreases with temperature. The value of K₂ can be manipulated to balance those opposing temperature dependencies.

Circuits that produce reference voltages are subject to errors in manufacturing as with any other circuit. Rather than discard all the circuits that deviate from the desired characteristics, manufacturers include circuitry that can be modified to correct the deviations. Testing and correction of deviations can add a great deal to the average cost of manufacturing. For this reason, efficient correction circuitry and methods of correction are important.

### SUMMARY OF THE INVENTION

The present invention is directed to a reference voltage adjusting circuit, a method for adjusting a circuit element, and systems employing the apparatus or method.

In an embodiment of the system for adjusting a circuit element of the present invention, two registers are connected to an adder. The adder outputs the sum of the two registers. The adder output is coupled to a group of switches.

In a more specific embodiment of the present invention, each of the registers includes an EPROM and an SRAM that are connected to a multiplexor. In another more specific embodiment of the invention, the switches are connected to shorting pathways that are each positioned across a circuit element. Those circuit elements are resistors. In another more specific embodiment of the invention, the switches include CMOS transistors. In another more specific embodiment of the invention, the register EPROMs are adapted to be programmed with the data stored in the register SRAMs.

In a method embodiment of the present invention, a first set of bits is temporarily stored in memory. A plurality of switches are controlled at least in part by the first set of bits. The first set of bits are permanently stored in memory. A second set of bits is stored in memory temporarily. The switches are controlled at least in part by the sum of the two sets of bits. The second set of bits are permanently stored in memory.

In another more specific method embodiment of the invention, a circuit element is adjusted by the switches and the output of the circuit element is compared to a specific output. In another more specific embodiment of the invention, the circuit element output resulting from the first set of bits is compared with the lower and upper bounds of an initial range. If the output is outside the range the first set of bits is modified. The modification depending upon whether the output is above or below the range. In another more specific embodiment of the invention, the circuit element output resulting from the sum of the first and second sets of bits is compared to a range calculated at least in part from the output resulting from the first set of bits that fell within the initial range.

In another method embodiment of the present invention, a resistor is modified in accordance with a first adjustment. A voltage is measured at a particular temperature. The measured voltage is compared to the bounds of an initial range. If the voltage is outside the initial range, the first adjustment is changed and the measurement is repeated. The resistor is modified in accordance with both the first adjustment and a second adjustment. The voltage is measured at a new temperature. If the voltage measured at the new temperature does not fall within a specific range, the second adjustment is changed and the measurement is repeated. In another more specific embodiment of the invention, the changes in the first and second adjustments are implemented in accordance with a binary search algorithm. In another more specific embodiment of the invention, the first adjustment is stored in an EPROM when the measured voltage is within the initial range. In an alternative embodiment of the invention, the first and second adjustments are stored in at least one EPROM when the measured at the new temperature falls within the specific range.

A feature of the invention is adjusting a circuit element.

Another feature is adjusting a reference voltage.

Another feature is adjusting reference voltage behavior at two temperatures.

An advantage of the present invention is modifying a circuit element after manufacture.

Another advantage is modifying a circuit element based on its characteristics at two temperatures.

Still another advantage is decreasing testing time for trimming a reference voltage.

Another advantage is trimming voltage references for CMOS devices.

Another advantage is identifying failed circuits.

Other and further features and advantages will be apparent from the following description of presently preferred embodiments of the invention, given for the purpose of disclosure and taken in conjunction with the accompanying drawings. Not all embodiments of the invention will include all the specified advantages. For example, one embodiment may only modify a circuit element after manufacture, while another only adjusts reference voltage behavior at two temperatures.

### BRIEF DESCRIPTION OF THE DRAWINGS

FIG. 1 is a circuit diagram of a system for modifying a resistor;

FIG. 2 is a flow diagram of a first portion of one embodiment of a method for adjusting a voltage;

FIG. 3 is a flow diagram of a second portion of one embodiment of a method for adjusting a voltage;

FIG. 4 is a diagram of a binary search tree employed in one embodiment of a method for adjusting a voltage; and

FIG. 5 is table of codes for the symbols used in the binary search tree of FIG. 4.

### DETAILED DESCRIPTION OF THE PREFERRED EMBODIMENTS

Referring now to the drawings, the details of preferred embodiments of the invention are schematically illustrated. Like elements in the drawings will be represented by like numbers, and similar elements will be represented by like numbers with a different lower case letter suffix.

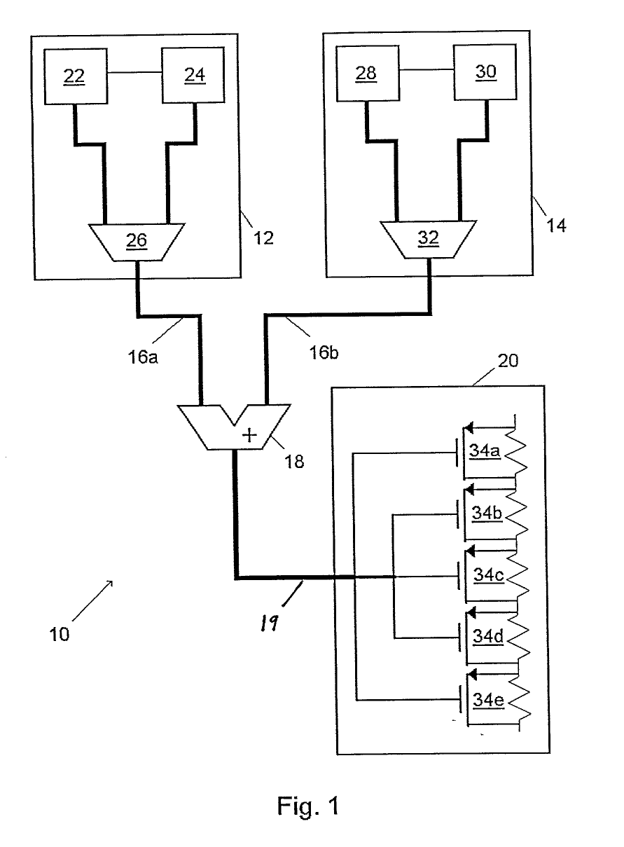

Referring to FIG. 1, a circuit diagram of an electronic system for modifying a resistor is illustrated. The electronic system is generally represented by the numeral 10. The electronic system 10 can be fabricated as a portion of a larger integrated circuit. The integrated circuit package may be, for example, but not limited to, plastic dual in-line package (PDIP), small outline (SO), shrink small outline package (SSOP), thin shrink small outline package (TSSOP), windowed ceramic dual in-line package (CERDIP), leadless chip carrier (LCC), plastic leaded chip carrier (PLCC), plastic quad flatpack package (PQFP), thin quad flatpack package (TQFP), pin grid array (PGA), ball grid array (BGA), TO-220, T0-247 and T0-263.

The electronic system 10 includes two registers: a primary trim register 12 and a secondary trim register 14. The primary trim register 12 outputs four bits onto a first bus 16a. The secondary trim register 14 outputs four bits onto a second bus 16b. The adder 18 calculates a five bit sum from the four bit values received on the first and second buses 16a,16b and outputs that sum onto a third bus 19. The third bus is received by a trim circuit 20. The trim circuit 20 is adaptable between many different resistances, thirty-two in the preferred embodiment. The resistance of the trim circuit 20 when divided by a second, set resistance implements the K₂ factor of the bandgap voltage reference equation. Thus, changes in the resistance of the trim circuit 20 affect the temperature dependence of the bandgap voltage reference. In alternative embodiments, the electronic system 10 can be used to adjust other circuit elements such as capacitors. In other alternative embodiments, the number of bits of the trim registers and the adder output can be increased or decreased. It is not necessary that the number of bits of the primary and secondary registers be equal. In an alternative embodiment, the bits from the primary and secondary registers are combined in a circuit other than an adder.

In the preferred embodiment, both the primary 12 and secondary 14 trim registers include different types of memory. The primary trim register 12 includes a first SRAM 22 having four bits. SRAM stands for static random access memory. SRAM can be programmed and reprogrammed as is well known in the art. The primary trim register also includes a first EPROM 24 having four bits. EPROM stands for erasable programmable read-only memory. The first SRAM 22 is connected to the first EPROM 24 such that the first EPROM 24 can be programmed with the data stored in the first SRAM 22. In alternative embodiments, another reprogrammable memory could be used in place of SRAM and/or another memory could be used in place of the EPROM. A first multiplexor 26 controls whether the first bus 16a receives the data stored on the first SRAM 22 or the data stored on the first EPROM 24. The first multiplexor 26 is controlled by test software run externally. In the preferred embodiment, the first multiplexor 26 is controlled to pass through the data from the first SRAM 22 until the first EPROM 24 is programmed, at which point the first multiplexor 24 passes the EPROM data.

The secondary trim register 14 includes a second SRAM 28, a second EPROM 30, and a second multiplexor 32. The second SRAM 28 and the second EPROM 30 each have four bits. The second SRAM 28 is connected to the second EPROM 30 such that the second EPROM 30 can be programmed with the data stored in the second SRAM 28. The second multiplexor 32 controls whether the second bus 16b receives the data stored on the second SRAM 28 or the data stored on the second EPROM 30. The second multiplexor 32 is controlled by test software run externally. In the preferred embodiment, the second multiplexor 32 is controlled to pass through the data from the second SRAM 28 until the second EPROM 30 is programmed, at which point the second multiplexor 32 passes the EPROM data.

The trim circuit 20 is coupled to the third bus 19. In the preferred embodiment, the third bus 19 carries five bits at a time on five lines. Each of the lines terminates at a PMOS switch 34a-e that controls a shorting pathway across a portion of the resistor. The portions of the resistor shorted by the PMOS switches 34a-e are binary weighted in the preferred embodiment. In other words, the portion of the resistor bypassed by PMOS switch 34b has a resistance twice that of the portion bypassed by PMOS switch 34a. The portion bypassed by PMOS switch 34e has a resistance sixteen times that bypassed by PMOS switch 34a. When all of the switches 34a-e are activated, the trim circuit has a minimum resistance because the portions of the resistor across which the switches are placed are shorted. When none of the switches 34a-e are activated, the trim circuit has a maximum resistance because no portion of the resistor is shorted. In the preferred embodiment, thirty equally spaced adjustable resistances are possible between those two extremes. In alternative embodiments, fewer or more resistances are possible and equal spacing is not necessary.

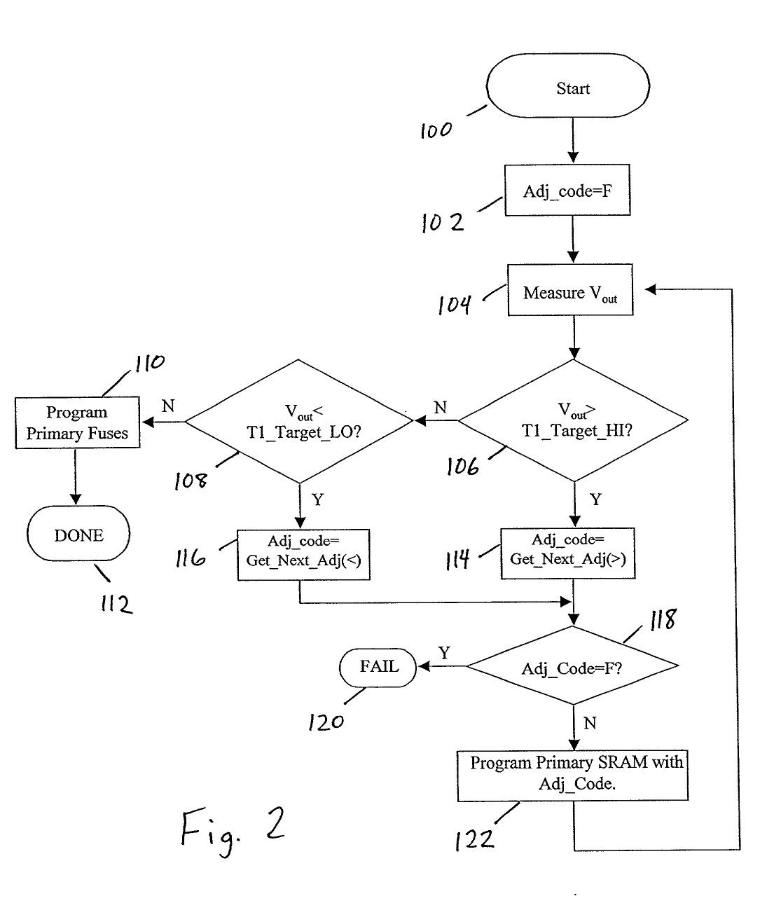

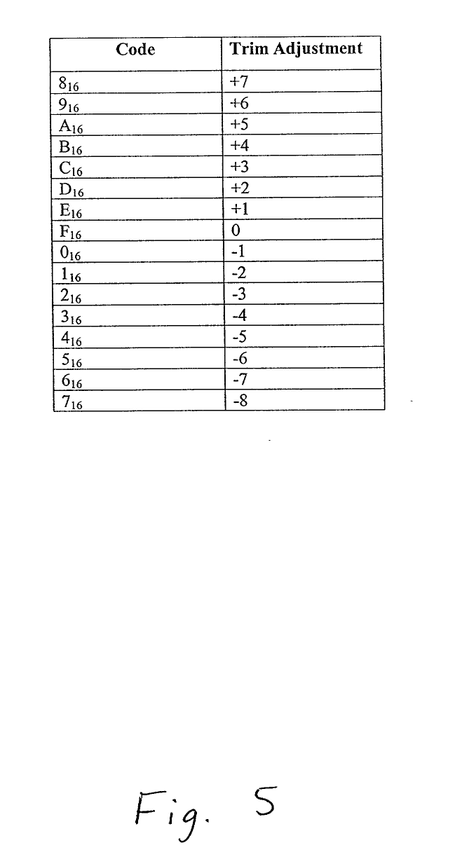

FIG. 2 is a flow diagram of a first portion of one embodiment of a method for adjusting a voltage. The method is preferably implemented in software resident on testing hardware that is external of the electronic circuit 10, but can be coupled to it. The start 100 of the method assigns an adjustment code, Adj_code, of F 102. Adjustment codes are hexadecimal numbers and represent data loaded into an SRAM, in this case the first SRAM 22. In hexadecimal notation F represents 1111 in binary. In the electronic circuit 10, the adder 18 will output bits that activate the switches 34a-e such that the resistance of trim circuit 20 corresponds to the sum of the trim adjustments for the two four-bit inputs. In an alternative embodiment, the adder 18 could be a bit-wise adder and the trim adjustments would correspond in value to the hexadecimal notation of the adjustment codes. For example, the adjustment code of 8 could represent a midpoint trim circuit resistance for a bitwise adder. The values of the adjustment codes are further discussed with reference to FIG. 5.

After setting an adjustment code of F 102, the output voltage, Vₒᵤₜ, is measured 104. This measurement occurs at a specified first temperature, T₁. The Vₒᵤₜ corresponds to the resistance of the trim circuit 20. The measured Vₒᵤₜ is compared 106 to the high bound of an initial range for the first temperature, T1_{—Target}_HI, and if it is less it is then compared 108 to the low bound of the initial range, T1_{—Target}_LO. If the measured Vₒᵤₜ falls within T1_Target_High and T1_Target_LO, the first EPROM 24 is programmed 110 with the values from the first SRAM 22. In one embodiment, when the first EPROM 24 is programmed, the voltage that fell within the range is also recorded in the test hardware. In another embodiment, that voltage is not recorded, but rather approximated as the average of T1_Target_LO and T1_{—Target}_HI.

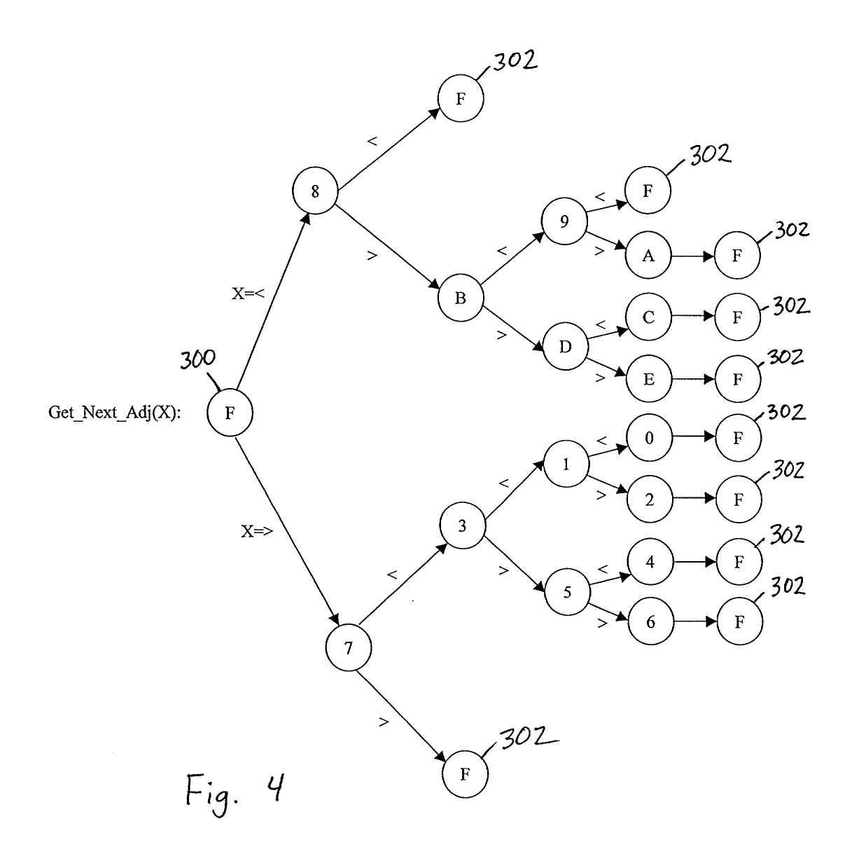

The measured Vₒᵤₜ may not fall within the required range for the first temperature with the midpoint trim circuit 20 resistance. If Vₒᵤₜ is too high, the adjustment code is reset 114 according to the “greater than” branch of the binary tree. In general, this adjustment splits the difference of the untried possible trim resistances that will lower Vₒᵤₜ. If Vₒᵤₜ is too low, the adjustment code is reset 116 according to the “lesser than” branch of the binary tree. In general, this adjustment splits the difference of the untried possible trim resistances that will raise Vₒᵤₜ. A more detailed description of the reset procedure of the adjustment codes is discussed with respect to FIGS. 4 and 5. The binary search concludes at the midpoint resistance, adjustment code F, if no options are left, see FIG. 4. After resetting the adjustment code it is checked 118 to see if that point was reached. If it has, the method concludes that the trim circuit 20 is unable to achieve a resistance that will satisfy the Vₒᵤₜ requirements and the circuit fails 120. If the adjustment code is not F, the first SRAM 22 is reprogrammed 122 with the bits corresponding to the new adjustment code and the output voltage is measured at the first temperature again 104.

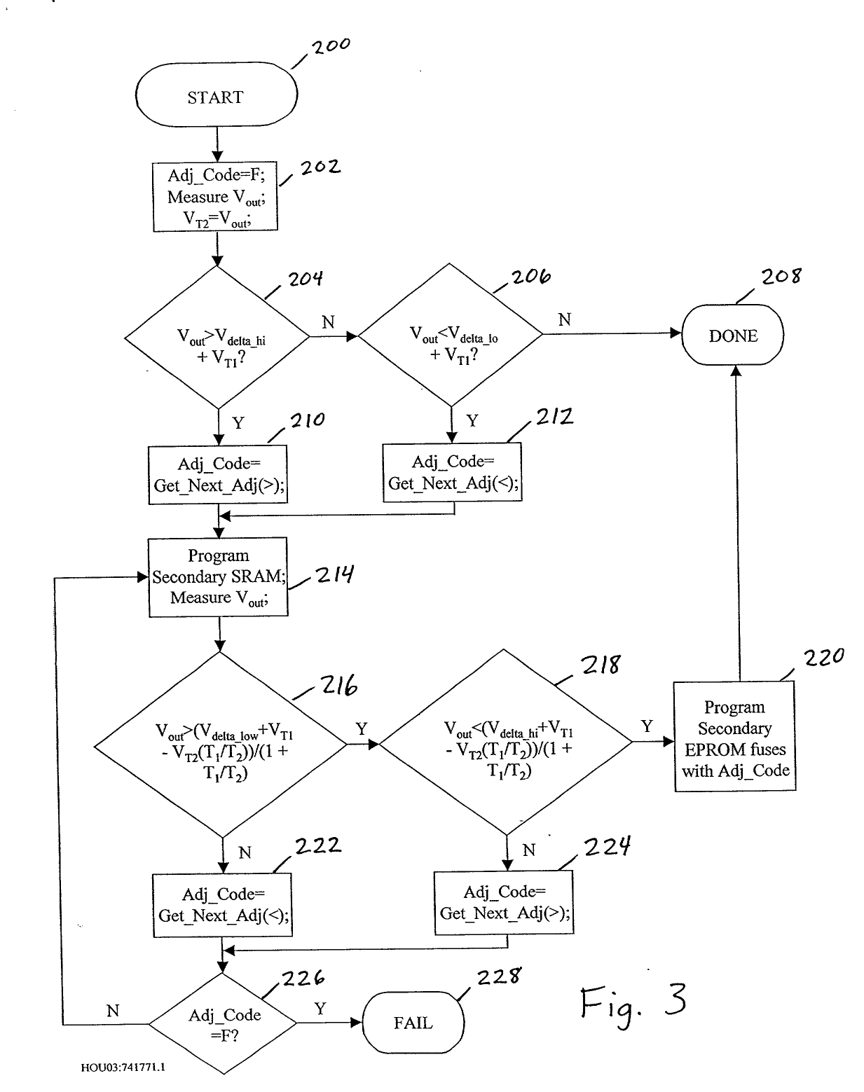

FIG. 3 is a flow diagram of a second portion of one embodiment of a method for adjusting a voltage. This portion of one method embodiment determines the proper value to program in the second EPROM 30, or fails if there is no such value. The value sets the temperature coefficient of the reference voltage, by measuring the output voltage at a second temperature. The adjustment is based on the difference between the voltage that was measured or approximated for the final primary resistor 12 setting at the first temperature and the voltage measured at a second temperature. This difference is correlated to an overall temperature coefficient by characterization. The output voltage changes across temperature for different trim codes. The relationship between the change in voltage at a first temperature and the change in voltage at a second temperature resulting from a change in resistance of the trim circuit 20 can be shown as:

(V₂−V₂′)/(V₁−V₁′)=T₂/T₁

where T₁ and T₂ are Kelvin-scale temperatures at which the voltage measurements where taken. That equation can be manipulated to solve for V₂′−V₁′:

V₂′−V₁′=V₂′−V₁+(V₂−V₂′)(T₁/T₂)

This equation is used to determine ranges for comparison to new adjustment codes.

The start 200 of the second portion of the method preferably follows the programming 110 of the first EPROM 24. In alternate embodiments, the first register 12 continues to operate based on the data in the first SRAM 22 and the first EPROM 24 is not programmed until after the second register 14 value has been determined. The adjustment code, Adj_Code, is set 202 at the midpoint, F. The output voltage Vₒᵤₜ is then measured at the second temperature, T₂, and the initial second temperature voltage is stored as V_{T2}. The second temperature output is compared 204 to the high bound of a range calculated from the final first temperature voltage, whether stored or approximated. If it is lower than the high bound, it is compared 206 to the low bound of a range calculated from the final first temperature voltage. If it is within the range, the current value of the second EPROM 30 is sufficient (the second EPROM 30 default value corresponds to adjustment code F) and the adjustment is concluded 208.

The measured Vₒᵤₜ may not fall within the required range for the second temperature with the midpoint trim circuit 20 resistance. If Vₒᵤₜ is too high, the adjustment code is reset 210 according to the “greater than” branch of the binary tree. In general, this adjustment splits the difference of the untried possible trim resistances that will lower Vₒᵤₜ. If Vₒᵤₜ is too low, the adjustment code is reset 212 according to the “lesser than” branch of the binary tree. In general, this adjustment splits the difference of the untried possible trim resistances that will raise Vₒᵤₜ. A more detailed description of the reset procedure of the adjustment codes is discussed with respect to FIGS. 4 and 5. The new adjustment code determines a new set of bits that are programmed 214 into the second SRAM 28. The output voltage is again measured at the second temperature.

The change in the secondary register 14 modifies the expected output voltage at the first temperature, because the trim circuit 20 now has a different resistance. The range that corresponds to the desired coefficient is modified in accordance with the equation for V₂′−V₁′.In the preferred embodiment, the second and subsequent voltage measurements made at T₂ are compared to a newly calculated range as shown in comparison steps 216 and 218. As before, if the output voltage falls within the range, the correct adjustment has been found and the second EPROM 30 is programmed 220 with the second SRAM 28 data. If it is outside the range, the adjustment code is reset along one of the paths of the binary tree 222,224. If that reset results in an F code 226, no trim circuit configuration will support the required temperature coefficient and the trim process has failed 228. Otherwise, the testing continues with the new code programmed into the second SRAM 28.

FIG. 4 is a diagram of a binary search tree employed in one embodiment of a method for adjusting a voltage. The beginning point 300 and the end points 302 are all associated with adjustment code F. Each change in state, movement from one circle to another, is associated with either a “greater than” or a “less than” symbol. Those paths correspond to resetting the value from that contained in the first circle to that contained in the second circle in the flow diagrams of FIGS. 2 and 3. FIG. 5 is table of codes for the symbols used in the binary search tree of FIG. 4. For example, code F corresponds to an adjustment of 0, while code 3 corresponds to an adjustment of −4. Changes in the hexadecimal notation for a given adjustment can be made if changes to the adder 18 are also made such that the output of the adder activates switches to produce a resistance corresponding to the sum of the adjustments from each register.

The invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alternation and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A system for adjusting a circuit element, comprising:
a first register;
an adder coupled at a first input to the output of the first register and having a second input and an output;
a second register coupled to the second input of the adder; and
a plurality of switches coupled to the output of the adder.

2. The system of claim 1, wherein the first register includes:
a first multiplexor having at least first and second inputs and an output;
a first reprogrammable memory coupled to the first input of the first multiplexor; and
a first programmable memory coupled to the second input of the first multiplexor, and the second register includes
a second multiplexor coupled to the second input of the adder and having at least first and second inputs;
a second reprogrammable memory coupled to the first input of the second multiplexor; and
a second programmable memory coupled to the second input of the second multiplexor.

3. The system of claim 1, further comprising:
a plurality of shorting pathways each coupled to one of the switches and each positioned across a circuit element.

4. The system of claim 3, wherein the circuit elements are resistors.

5. The system of claim 4, wherein each resistor has a resistance that is a multiple of two in value in comparison to another resistor.

6. The system of claim 2, further comprising:
a first bus coupling the first multiplexor to the adder; and
a second bus, having the same number of lines as the first bus, coupling the second multiplexor to the adder.

7. The system of claim 6, further comprising:
a third bus, having one more line than the second bus, coupling the adder to the plurality of switches, and wherein each switch is controlled by the signal on at least one line of the third bus.

8. The system of claim 1, wherein the plurality of switches include PMOS transistors.

9. The system of claim 2, wherein the first and second programmable memories include at least one EPROM.

10. The system of claim 2, wherein the first and second reprogrammable memories include at least one static random access memory.

11. The system of claim 2, wherein each of the first and second programmable memories and the first and second reprogrammable memories include one less bit than the number of switches.

12. The system of claim 2, wherein each of the first and second programmable memories is adapted to be programmed with the data contained in the first and second reprogrammable memories, respectively.

13. The system of claim 2, wherein the output of the first multiplexor is equivalent to its second input after the first programmable memory has been programmed.

14. The system of claim 1, wherein the adder is a bitwise adder.

15. A method for adjusting a circuit element, comprising the steps of:
temporarily storing a first set of bits in memory;
controlling a plurality of switches based at least in part on a value associated with the first set of bits;
storing the first set of bits in non-volatile memory,
temporarily storing a second set of bits in memory, the second set of bits associated with a value;
controlling the plurality of switches based at least in part on the sum of the values associated with the first and second sets of bits; and
storing the second set of bits in non-volatile memory.

16. The method of claim 15, further comprising the steps of:
adjusting the circuit element in accordance with the plurality of switches controlled at least in part based on the value associated with the first set of bits; and
comparing the output of the circuit element with at least one specified output.

17. The method of claim 16, wherein the step of comparing includes
checking if the output is greater than a specified high output and, if it is not, checking if the output is less than a specified low output; and wherein
the specified high output is greater than the specified low output.

18. The method of claim 17, wherein the first set of bits is modified if the output is greater than the specified high output and the first set of bits is modified differently if the output is less than the specified low output.

19. The method of claim 15, further comprising the steps of:
adjusting the circuit element in accordance with the plurality of switches controlled at least in part based on the sum of the values associated with the first and second sets of bits to produce a summed output; and
comparing the summed output of the circuit element with at least one specified output.

20. The method of claim 19, wherein the step of comparing includes
checking if the output is greater than the sum of a specified high delta and a first set output and, if it is not, checking if the output is less than the sum of a specified low delta and a first set output; and
the specified high delta is greater than the specified low delta.

21. The method of claim 20, wherein the first set output is approximated.

22. The method of claim 20, wherein the first set output is measured.

23. A method for adjusting a voltage, comprising the steps of:
(a) modifying a resistor in accordance with a first adjustment;
(b) measuring the voltage at a first temperature;
(c) checking whether the measured voltage is within a first acceptable range;
(d) if the measured voltage is outside the first acceptable range, changing the first adjustment and repeating steps (a)-(c);
(e) modifying the resistor in accordance with both the first adjustment and a second adjustment;
(f) measuring the voltage at a second temperature;
(g) checking whether the measured voltage is within a second acceptable range; and
(h) if the measured voltage is outside the second acceptable range, changing the second adjustment and repeating steps (e)-(g).

24. The method of claim 23, wherein the second acceptable range is calculated based at least in part on a value within the first acceptable range.

25. The method of claim 23, wherein steps (d) and (h) change the first and second adjustments differently depending upon whether the measured voltage was greater than or less than the range.

26. The method of claim 25, wherein steps (d) and (h) change the first and second adjustments in accordance with a binary search algorithm.

27. The method of claim 23, further comprising the step of:
(d′) if the measured voltage is within the first acceptable range, storing the first adjustment in an EPROM.

28. The method of claim 23, further comprising the step of:
(i) if the measured voltage is within the second acceptable range, storing the first adjustment and the second adjustment in at least one EPROM.
